(19) United States
(12) Patent Application Publication
(10) Pub. No.: US 2011/0137699 A1
(43) Pub. Date: Jun. 9, 2011

(54) METHOD AND SYSTEM FOR CAB MANAGEMENT

(76) Inventors: Ronen Ben-Ari, Ramat Hasharon (IL); Amnon Levy, Ramat Hasharon (IL)

(21) Appl. No.: 13/057,766

(22) PCT Filed: May 2, 2009
(86) PCT No.: PCT/IB09/53353

§ 371 Date: Feb. 7, 2011

Related U.S. Application Data
(60) Provisional application No. 61/086,169, filed on Aug. 5, 2008.

(51) Int. Cl. G06Q 10/00

(52) U.S. Cl. 705/7.13

(57) ABSTRACT

It is provided a super territorial service center for allocating orders for payable back travels to location-related service providers traveling outside their respective local territories The service center receives service orders, receives data associated with location and availability of the service providers, and allocates service orders to service providers The service orders include service times, pick-up locations, and destinations in local territories different from the pick-up location The service center includes an order interface, a service provider interface and an allocating unit The order interface receives service orders from clients using the internet, telephony system, cellular networks, and indirectly through local dispatchers The service provider interface receives the data associated with location and availability of the service providers The allocating module searches appropriate service provider in a gradually increasing zone around the pick-up location, searches appropriate service provider, calculates travel time between locations, and prioritizes service provider

### CROSS REFERENCE TO RELATED APPLICATIONS

The present application claims the benefit of a U.S. provisional patent application No. 61/086,169, titled “Method and system for cab management” filed Aug. 5, 2008, by the present inventors.

### BACKGROUND OF THE INVENTION

1. Field of the Invention

The invention is in the field of transportation, and especially deals with cab, taxi, delivery, towing and moving businesses, whereas a location-related service provider is traveling outside a local territory and would like to make use of a travel back home.

2. Description of Related Art

Cab drivers traveling to destinations outside of their home base station region may take advantage of only half of their time. This inefficiency stems from an idle travel back without a passenger since their home station, which provides most of their orders, is not able to take orders in that far destination.

Similar inefficiency occurs also in the business of couriers, movers, tow truck drivers, mobile service providers, etc, each with the respective provided service. For clarity and brevity, this disclosure refers mainly to cab drivers and cab management. However, the present invention is applicable for the aforementioned businesses, each with the corresponding adaptations and fits.

It would be advantageous to provide a system and a method for a cab management system wherein destination data is the main starting point in selecting a cab for a drive. Such a system is inherently more efficient in converting an idle drive back from a far destination into a payable drive.

### BRIEF SUMMARY OF THE INVENTION

It is provided according to certain implementations of the invention, a super territorial service center for allocating orders for payable back travels to location-related service providers traveling outside their respective local territories. The service center is configured for receiving service orders, receiving data associated with location and availability of the service providers, and allocating service orders to service providers. The service orders include service times related to the service order, pick-up locations, and destinations in local territories different from the pick-up location. The allocating is done in accordance with the pick-up locations, the service times, and the data associated with location and availability of the service providers.

In some embodiments, the service center is linked to a wide area network.

In some embodiments, the service center includes an order interface configured for receiving service orders from a client using the internet, telephony system, and cellular networks. In addition, the order interface may receive orders from the client indirectly through a local dispatcher at a local territory associated with the pick-up location or with the destination.

In some embodiments, the service center includes a service provider interface configured for receiving the data associated with location and availability of the service providers traveling outside respective local territories. The data may be received directly from the service provider using location and communication means associated with the service provider. Exemplary location and communication means are a global positioning system (GPS) device and a cellular modem, and they may feed the data to a service provider database associated with the super territorial service center. The location and communication means are used for frequent reporting of location to the service center, whereby the reported locations are used by the service center for analysis and calculation of traffic loads. Also, the location and communication means may have a status indicator indicating the availability of the service provider, whereby the status indicator is frequently transferred to the service center.

The data may be received indirectly from the service provider through a local dispatcher associated with the service provider and with the super territorial service center.

In some embodiments, the service center includes an allocating module configured for searching appropriate service provider associated with the pick-up location and the service time in a gradually increasing zone around the pick-up location, searching appropriate service provider having a respective local territory in a gradually increasing zone around the destination location, and calculating travel time between two locations based on available routes and traffic data, and prioritizing service providers in accordance with distance between a certain location and the respective local territory. For the last task the allocating module may include a unit for calculating travel times.

In some embodiments, the service center includes an interface for a super territorial dispatcher, the interface is linked to a human interface, whereby a super territorial dispatcher is monitoring and operating the service center using the human interface.

It is provided according to certain implementations of the invention, a method for allocating a service order providing payable back travel to location-related service providers traveling outside respective local territories. The method includes receiving service orders, receiving data associated with location and availability of the service providers, and allocating service order to service providers. The service orders include related service times, pick-up locations, and destinations in local territories different from the respective pick-up locations. The allocating is done in accordance with the pick-up locations, service times, and the respective data associated with location and availability of the service provider.

The method is a computerized method which uses a server connected to a wide area network as a service center. The service order may be received, directly from clients using the internet, telephony system, and cellular networks. It also may be received indirectly from a client through a local dispatcher at either a local territory of the pick-up location or a local territory of the destination.

In some embodiments, the data associated with location and availability of the service providers traveling outside respective local territories is received indirectly from the service provider through a local dispatcher associated with the service provider.

In some embodiments, the allocating of service order to a service provider includes stepwise searching of appropriate service provider associated with a gradually increasing zone around the pick-up location. In addition, the allocating may include stepwise searching of appropriate service provider having a respective local territory in a gradually increasing zone around the destination location.

A program of instructions executable by a computerized apparatus to perform the above mention method may be stored in a storage device readable by the computerized apparatus.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 illustrates an exemplary national map with a plurality of local territories.

FIG. 2 illustrates an exemplary national map with a national territory served by a super territorial service center.

FIG. 3 is a block diagram of a super territorial service center associated with clients, service providers and local dispatchers.

FIG. 4 is a flow chart of a method for allocating payable back travel orders to service providers.

FIG. 5 depicts several actions included in the step of allocating service orders to service providers.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described set-up is necessary to implement the invention as claimed in any particular one of the appended claims. Various elements and features of device are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The inefficiency of idle back travel occurs in the business of cabs, couriers, movers, tow trucks, etc, each with the respective provided service. For clarity and brevity, this disclosure emphasizes cab drivers and cab management. However, the present invention is applicable for the aforementioned businesses, each with the corresponding adaptations and fits for the specific business.

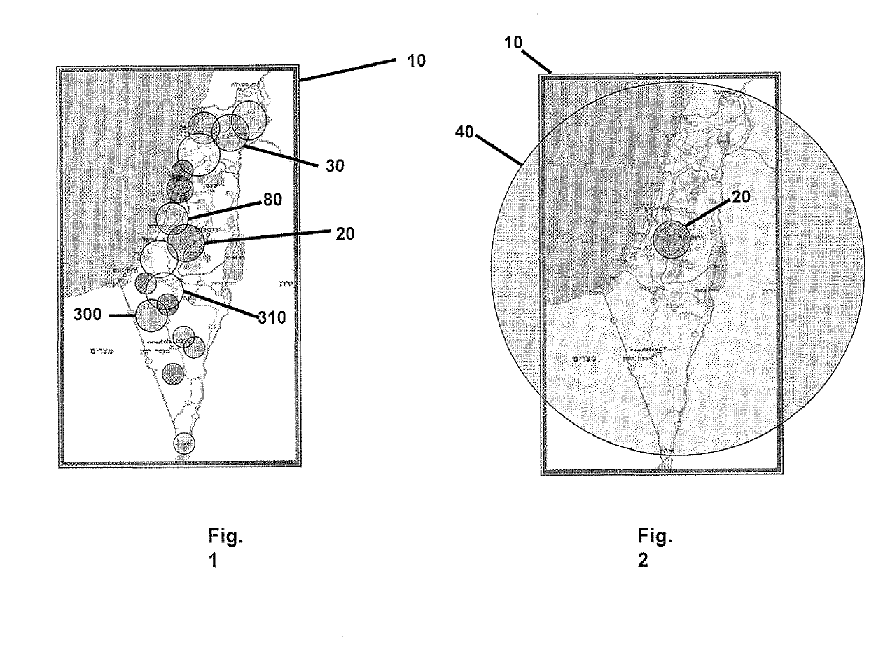

Cab drivers traveling to destinations outside of their home base station region may take advantage of only half of their time. Map 10 of FIG. 1 shows an exemplary local territory 20 where a local cab station or taxi company (hereafter local dispatcher) is serving clients. The local dispatcher receives a service order to give a ride to a client to another local territory 30, 200 km away. The local dispatcher allocates the service order to a cab driver associated with him. Once the cab driver completes the order in local territory 30, the local dispatcher at local territory 20 is unable to provide him a service order to travel back to local territory 20 while being paid. Thus, the service provider is paid for only half the way he travels, inefficiently using the time, gas and mileage resources. This inefficiency has undesired aspects: the client ordering the travel outside the local territory has to pay, at least in part, also the time and gas for the back travel, whereas to be competitive the service provider avoids charging the client for all the time and gas for back travel. Also, gas is consumed without any economic benefit, but with some unwanted addition of carbon dioxide to the atmosphere. In addition, a cab from local territory 30 has to travel to local territory 20 and return idly.

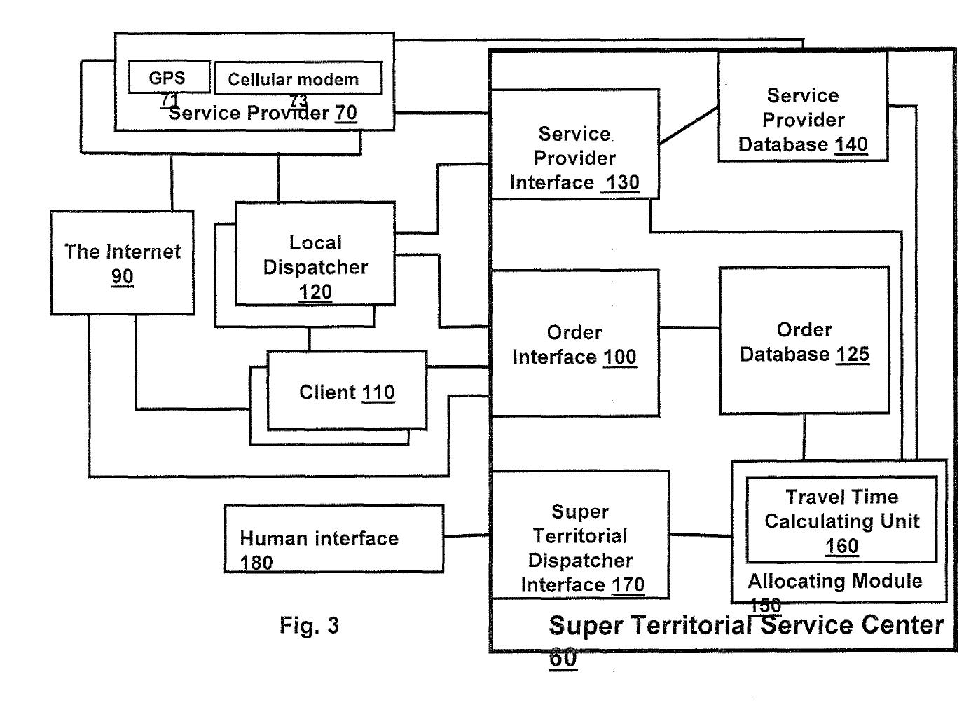

Referring now to FIG. 2, a super-territory 40 is outlined on map 10, covering an area legally and practically accessible to service providers of all the local territories of FIG. 1. FIG. 3 is a block diagram of a super territorial service center (hereafter service center or STESEC) 60 for allocating an order for payable back travel to location-related service providers 70 traveling outside their respective local territories 20 and 30. The service center 60 is receives service orders, receives data on location and availability of the service providers 70, and allocates service orders to service providers. A typical service order include pick-up time, time-at-destination, pick-up location, and destination in a local territory 20 or 80 which is different from the pick-up location. The allocating is done in accordance with the service order and with the data on location and availability of the service provider.

STESEC 60 is linked to wide area networks, the internet 90, the line telephony network, and the cellular network, for example.

The service center 60 includes an order interface 100 configured for receiving service orders from a client using the interne 90, telephony network system, and cellular networks. A service order may be received using phones by a human operator or by an automatic vocal response system. In addition, order interface 100 may receive orders from the client indirectly through a local dispatcher 120 at a local territory 30 in which the pick-up location is located, or through a local dispatcher at a local territory 80 in which the destination is located. The received orders may be stored in an order database 125.

Service center 60 includes a service provider interface 130 configured for receiving the data associated with location and availability of the service providers 70 traveling outside respective local territories. The data may include, certain time ahead, details of a planned travel, as well as details of a present travel and of a travel just ended. Also, the data may include location and availability details having no connection to a business travel to the far territory. For example, a cab driver that had joined a child to an airport in local territory 30 is available to receive a service order while traveling back to his local territory 20, and lets STESEC 60 know that in order to get a service order. Also, a cab driver associated with STESEC 60 may get an order either through a local dispatcher or by picking-up a client off street, and feed the destination to a global positioning system (GPS) device 71, which in turn submit the present location and destination to STESEC 60. The travel time is calculated and the location and time of availability is stored in the service provider database 140 for future use.

Note that, a cab driver 70 leaving outside the local territory 20 of the associated dispatcher, may use STESEC 60 to get service orders for commuting back and forth between house and local territory 20.

The data may be received directly from the service provider using location and communication means like a global positioning system (GPS) device 71 and a cellular modem 73. Those devices may feed the data to a service provider database 140 included in the super territorial service center 60, from which the service provider interface 130 may retrieve the data. Moreover, a device based on a GPS 71 may get a destination of a service order and may be able to calculate the expected arrival time and feed it to the database 140. Conversely, the service provider interface 130 may store data on current and future location and availability of the service providers in database 140.

In addition, the data on availability of service provider 70 may be received indirectly from the service provider 70 through a local dispatcher 120 serving the local territory 20 of the service provider 70. The local dispatcher 120 may be associated with STESEC 60 on a long term basis or per order. In any case, the local and super territorial dispatchers share a fee paid by the service provider 70 or by the client 110.

The data on availability of a cab driver 70, for example, may include a status flag which corresponds one of several states: occupied, available, future availability, order call confirmed, passenger pickup confirmation (occupied by the order allocated by STESEC 60). Cab driver 70 associated with cab management system 60 may be free to control when he is ready to serve cab management system 60, allowing him to further connect to a local station or to serve passengers associated with him in other ways. Whenever available, the cab driver changes his status in a terminal connected to cab management system 60 to “available”. Consequently, the system combines this piece of data with his current location and the location of his home base station 120 and may match him to a passenger.

A service provider 70 may feed every destination he get to a GPS based terminal, which in turn calculate the expected arrival time and feed that data to STESEC 60.

The service center includes an allocating module 150 for searching appropriate service provider 70 associated with the pick-up location and the pick-up time, searching appropriate service provider 70 having a respective local territory 20 at or near the destination, calculating travel time between two locations based on available routes and traffic data, and prioritizing service providers in accordance with distance between the destination and their respective local territories 20 or 80.

Alternatively, the prioritization may be in accordance with distance between the pick-up location and the respective local territories 20 or 80. Allocating module 150 may include a unit 160 for calculating travel time.

Exemplary STESEC 60 of FIG. 3 includes an interface 170 for a super territorial dispatcher linked to a human interface 180, which is used by a super territorial dispatcher for monitoring and operating service center 60.

To elaborate on the connection between STESEC 60, service providers 70 and local dispatcher 120, a reference is made to cab management, as an example. The cab drivers 70 associated with cab management system 60 may be either independent cab drivers or cab drivers associated with a local station 120. In one embodiment, local stations 120 may join the management system as associate local stations. Priority rules are agreed upon between the cab management system and any of the local stations 120. Here is an exemplary set of rules:

Local station 120 allows its cab drivers to serve cab management system 60 whenever they are not necessary for serving the local station order calls.

Cab management system 60 grants the local station 120 a priority regarding passengers with a pick-up address in the local territory of the local station over other local territories, but not over cabs from far local territory who needs a service order for a back travel.

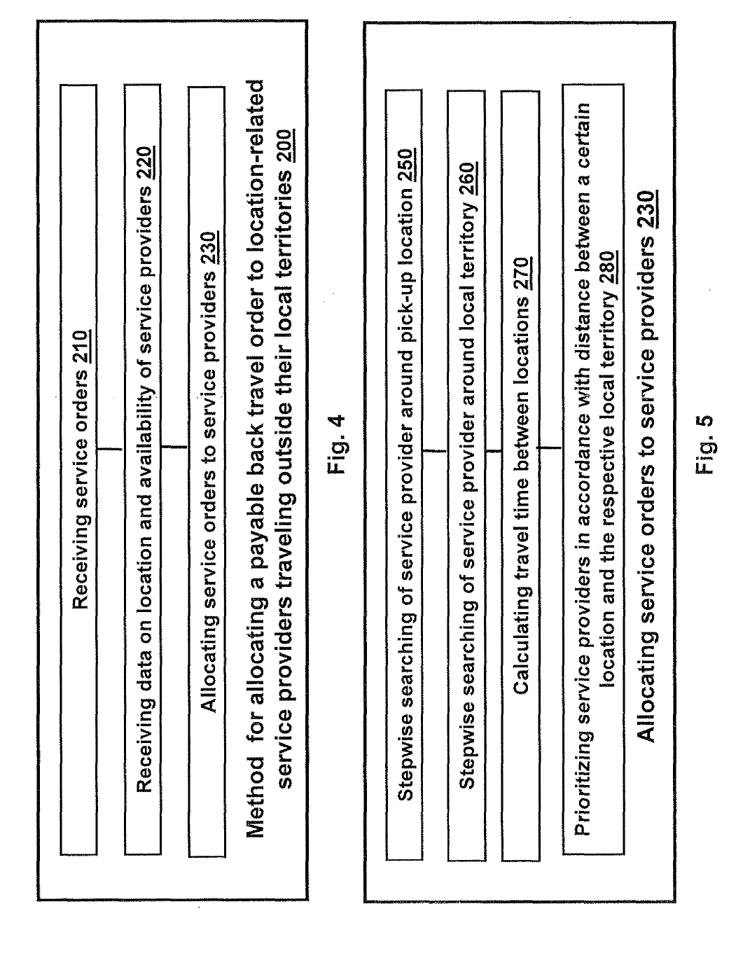

Referring now to FIG. 4, it presents the flowchart of a method 200 for allocating a service order providing payable back travel to location-related service providers 70 traveling outside respective local territories 20 and 80. The method includes the step 210 of receiving service orders, the step 220 of receiving data associated with location and availability of the service providers 70, and the step 230 of allocating service order to service providers. The service orders include related service times, pick-up locations, and destinations in local territories different from the respective pick-up locations. Note that the service order may include also service orders for destinations in the same local territory as the pick-up locations. For example, STESEC 60 may get agreement with local dispatcher at a certain territory 20 that it does not compete on service order at local territory 20, but has no such agreement with any local dispatcher at local territory 80. Thus, in local territory 80 it does takes local service order and provide them to associated service providers 70. The step 230 of allocating is done in accordance with the pick-up locations, service times, and the respective data associated with location and availability of the service provider.

Method 200 is a computerized method which uses a server connected to a wide area network as a service center 60. The service order may be received directly from clients using the interne, telephony system, and cellular networks. It also may be received indirectly from a client through a local dispatcher at either a local territory of the pick-up location or a local territory of the destination.

In some embodiments, the data associated with location and availability of the service providers traveling outside respective local territories is received indirectly from the service provider 70 through a local dispatcher 120 associated with the service provider 70.

Step 230 of allocating of service orders to service providers may include four actions, as depicted in FIG. 5:

1. The action 250 of stepwise searching of appropriate service provider associated with a gradually increasing travel time zone around the pick-up location. The travel time zone may be computed in a variety of ways. The simplest way is to use aerial distance around the pick-up location, and get concentric circular zones. A more complex way for outlining increasing zone areas is to calculate distance according to available routes. The most complex way is to calculate travel time on the available routes and outline the zone borders accordingly.

2. The action 260 of stepwise searching of appropriate service provider having a respective local territory in a gradually increasing travel time zone around the destination location.

3. The action 270 of calculating travel time between locations based on available routes and traffic data. This action may be used, for example, to calculate availability time of two service providers intended to complete their respective present order at different times and different locations proximate to a pick-up location for a service order. For each provider, the unit adds the travel time from the present location to the destination of the present order, and the travel time from the destination to the pick-up location of the service order.

The data on traffic, route condition and alike, may be obtained from a variety of sources: radio stations, national route control room, and propagating location data of service providers fed automatically to the service provider database 140.

4. The action 280 of prioritizing service providers 70 in accordance with distance between a certain location and the respective local territory. For example, two service providers are available to take a certain service order with a pick up location in local territory 30 and destination at local territory 300, as shown in FIG. 1. The local territories of the first and second providers are territories 310 and 20, respectively. The allocating unit 150 allocates the service order to the first service provider, as such an allocation saves a longer idle back travel.

Referring now to a cab management system 60, it may apply a priority algorithm to match a passenger with a cab driver 70. An exemplary algorithm takes into account the following considerations:

Match of the passenger needs and parameters of the cab.

Identification of a cab in a potentially idle travel to the destination address located close to home base station region or cab driver home at the end of the working day.

Travel time and distance of the cab to the passenger picking-up place.

Priority of a cab connected with a local station associated with the cab management system.

Waiting time of driver to passenger.

Priority of highly rated cab driver, whereas a rating system is constructed based on passengers complaints (or their absence) and compliance with the management system needs.

The cab management system 60 updates the cab location from time to time, each 15 seconds for example, and/or each time the cab traveled certain distance from the previous location, 500 meters for example.

The stepwise searching may be done in increasing radii around a pick-up location. Management system 60 may repeat the process of finding an appropriate cab driver for a certain number of times, five for example. It may enlarge the searching radius around a passenger pick-up location and around the destination location by 50%, for example. The initial search radius may be different for the pick-up address and destination address. Exemplary radii are 400-600 meter for the pick-up address and 3-6 km for the destination address. If no matching of a returning cab to the passenger is found, the system is calling another cab with optimal matching to the passenger needs.

Once a cab 70 fits a service order and the service order is allocated to him, STESEC 60 sends the cab driver the client details, cellular phone and name for example, and feeds the pick-up location and destination to a GPS device installed in cab 70. Moreover, details regarding traffic loads may also be fed to the GPS device, which in turn navigate the cab driver in accordance with traffic loads. On the other direction, the GPS device feeds location data frequently to STESEC 60, enabling mapping of real time traffic loads.

STESEC 60 may follow the cab in the way to the pick-up location and then on the way to the destination, intervening if desired to ensure that the service order is executed as desired. For example, it may send another cab 70 if a severe mechanical defect occurred to the cab having the service order in the way to the pick-up location.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

What is claimed is:

1. A super territorial service center for allocating a payable back travel order to one or more location-related service providers traveling outside respective local territories, the service center configured for:
(a) receiving at least one service order including at least one service time related to said service order, a pick-up location, and a destination in a local territory different from said pick-up location;
(b) receiving data associated with location and availability of the service providers traveling outside respective local territories; and
(c) allocating one of said at least one service order to one of said one or more service providers in accordance with at least said pick-up location, at least one service time, and said data associated with location and availability.

2. The service center of claim 1 wherein the service center is linked to a wide area network.

3. The service center of claim 1 wherein the service center includes an order interface configured for receiving service order from a client:
(i) using one channel of a group of channels consisting of the internet, telephony system, and cellular networks; and
(ii) through a local dispatcher at one of a local territory associated with said pick-up location and a local territory associated with said destination.

4. The service center of claim 1 wherein the service center includes a service provider interface configured for receiving said data associated with location and availability of the one or more service providers traveling outside respective local territories.

5. The service center of claim 4 wherein said data is received directly from the service provider using location and communication means associated with said service provider.

6. The service center of claim 4 wherein said data is received indirectly from the service provider through a local dispatcher, said local dispatcher being associated with the service provider and with the super territorial service center.

7. The service center of claim 5 wherein said location and communication means include at least one of a global positioning system device and a cellular modem.

8. The service center of claim 5 wherein said location and communication means are used for frequent reporting of location to the service center, whereby the reported locations are used by the service center for analysis and calculation of traffic loads.

9. The service center of claim 5 wherein said location and communication means has a status indicator indicating the availability of the service provider, whereby the status indicator is frequently transferred to the service center.

10. The service center of claim 5 wherein said location and communication means feed the data to a database associated with said super territorial service center.

11. The service center of claim 1 wherein the service center includes an allocating module configured for at least one of:
(i) searching appropriate service provider associated with said pick-up location and said at least one service time in a gradually increasing zone around said pick-up location;
(ii) searching appropriate service provider having a respective local territory in a gradually increasing zone around said destination location;
(iii) calculating travel time between two locations based on available routes, and traffic data; and
(iv) prioritizing service providers in accordance with distance between a certain location and the respective local territory.

12. The service center of claim 11 wherein said allocating module includes a travel time calculating unit configured for said calculating travel time between two locations.

13. The service center of claim 1 wherein the service center is associated with a service provider database configured for receiving the data associated with location and availability of the service providers.

14. The service center of claim 1 wherein said service center includes an interface for a super territorial dispatcher, said interface linked to a human interface, whereby a super territorial dispatcher is monitoring and operating said service center using said human interface.

15. A method for allocating a payable back travel order to one or more location-related service providers traveling outside respective local territories, the method comprising:
(a) receiving at least one service order including at least one service time related to said service order, a pick-up location, and a destination in a local territory different from said pick-up location;
(b) receiving data associated with location and availability of the one or more service providers traveling outside respective local territories; and
(c) allocating one of said at least one service order to one of said one or more service providers in accordance with at least said pick-up location, at least one service time, and the respective data associated with location and availability of the service provider.

16. The method of claim 15 wherein the method is a computerized method based on using a server connected to a wide area network.

17. The method of claim 15 wherein said at least one service order is received directly from a client using one channel of a group of channels consisting of the internet, telephony system, and cellular networks.

18. The method of claim 15 wherein said data associated with location and availability of the one or more service providers traveling outside respective local territories is received directly from the service provider using location and communication means.

19. The method of claim 15 wherein said data associated with location and availability of the one or more service providers traveling outside respective local territories is received indirectly from the service provider through a local dispatcher associated with the service provider.

20. The method of claim 15 wherein the allocating of service order to a service provider includes one or more steps of searching appropriate service provider traveling in a gradually increasing zone around said pick-up location.

21. The method of claim 15 wherein the allocating of service order to a service provider includes one or more steps of searching appropriate service provider having a respective local territory in a gradually increasing zone around said destination location.

22. A program storage device readable by a computerized apparatus, tangibly embodying a program of instructions executable by the computerized apparatus to perform the method of claim 13.
